(19) United States
(12) Patent Application Publication
(10) Pub. No.: US 2026/0204247 A1
(43) Pub. Date: Jul. 16, 2026

(54) METHODS AND SYSTEMS FOR ACTIVE NOISE CONTROL IN AN AUDIO PLAYBACK DEVICE

(71) Applicant: SAMSUNG ELECTRONICS CO., LTD., Suwon-si (KR)

(72) Inventors: Rishabh GUPTA, Bangalore (IN); Munukutla L N Srinivas Karthik, Kakinada (IN); Omsrinath Chelamkuri, Bangalore (IN); Raj Narayana Gadde, Banalore (IN); Kyoungbo Min, Suwon-si (KR); Yughendaran Palanivel, Chidamaram (IN)

(21) Appl. No.: 19/563,275

(22) Filed: Mar. 11, 2026

Related U.S. Application Data
(63) Continuation of application No. PCT/KR2025/018625, filed on Nov. 12, 2025.

(30) Foreign Application Priority Data
Nov. 16, 2024 (IN) 202441088698
Nov. 29, 2025 (IN) 202441088698

(51) Int. Cl. G10K 11/178

(52) U.S. Cl. CPC G10K 11/17881; G10K 11/17854

(57) ABSTRACT

Disclosed is a method for active noise control (ANC) in an audio playback device. An ambient audio signal and a feedback audio signal are received via a first audio input device positioned outwardly and a second audio input device positioned inwardly on the audio playback device, respectively. An estimated leaked signal is determined based on the ambient and feedback audio signals. An initial anti-noise audio signal corresponding to dominant noise sources within a plurality of sub-bands of the ambient audio signal is extracted. One or more ear canal parameters associated with a user are estimated based on the feedback audio signal, the estimated leaked signal, and the initial anti-noise audio signal. An anti-noise signal is generated for playback via the audio playback device based on the one or more ear canal parameters to achieve the ANC at the audio playback device.

### CROSS-REFERENCE TO RELATED APPLICATIONS

This application is a continuation of International Application No. PCT/KR2025/018625 designating the United States, filed on November 12, 2025, in the Korean Intellectual Property Receiving Office and claiming priority to Indian Provisional Patent Application No. 202441088698, filed on November 16, 2024, and Indian Complete Patent Application No. 202441088698, filed on October 29, 2025, in the Indian Patent Office, the disclosures of each of which are incorporated by reference herein in their entireties.

### BACKGROUND

### Field

The disclosure relates to active noise cancellation techniques, and for example, relates to methods and systems for active noise control (ANC) in an audio playback device.

### Description of Related Art

Active Noise Control (ANC) technology is widely used in audio devices to enhance user experience by generating anti-noise signals that effectively cancel an incoming ambient noise. ANC technology may reduce unwanted sound signal by adding a sound signal which is designed to cancel the unwanted sound signal. For example, ANC technology utilized one or more microphones to capture ambient sound, and generate a mirror anti-noise soundwave to cancel out the unwanted noise via destructive interference. ANC technology is widely used for various acoustic devices, such as earbuds. ANC system in earbuds using multiple internal and external microphones to monitor and counteract noise across a wide frequency range, allowing users to enjoy audio or silence more clearly by creating a quitter personal space despite surrounding distractions. Hybrid ANC combine both an external microphone, such as a feedforward microphone, and an internal microphone, such as a feedback microphone, to achive a broader frequency range of noise reduction and improved accuracy.

### SUMMARY

According to an example embodiment of the present disclosure, a method for active noise control (ANC) in an audio playback device is disclosed. The method includes: receiving, via a first audio input device comprising a microphone positioned outwardly on the audio playback device, an ambient audio signal; receiving, via a second audio input device comprising a microphone positioned inwardly on the audio playback device, a feedback audio signal; extracting, from the ambient audio signal, an initial anti-noise audio signal corresponding to dominant noise sources within a plurality of sub-bands of the ambient audio signal; estimating one or more ear canal parameters associated with a user of the audio playback device based on the feedback audio signal, an estimated leaked signal, and the initial anti-noise audio signal; and generating an anti-noise signal for playback via the audio playback device based on the one or more ear canal parameters to achieve the ANC at the audio playback device.

According to an example embodiment of the present disclosure, a system for active noise control (ANC) in an audio playback device is disclosed. The system includes: a memory and at least one processor, comprising processing circuitry, communicatively coupled to the memory, wherein at least one processor, individually and/or collectively, is configured to cause the system to: receive, via a first audio input device comprising circuitry positioned outwardly on the audio playback device, an ambient audio signal; receive, via a second audio input device comprising circuitry positioned inwardly on the audio playback device, a feedback audio signal; determine an estimated leaked signal based on the ambient audio signal and the feedback audio signal; extract, from the ambient audio signal, an initial anti-noise audio signal corresponding to dominant noise sources within a plurality of sub-bands of the ambient audio signal; estimate one or more ear canal parameters associated with a user of the audio playback device based on the feedback audio signal, the estimated leaked signal, and the initial anti-noise audio signal; and generate an anti-noise signal for playback via the audio playback device based on the one or more ear canal parameters to achieve the ANC at the audio playback device.

To further clarify the advantages and features of the present disclosure, a more detailed description will be rendered by reference to various example embodiments thereof, which are illustrated in the appended drawings. It is appreciated that these drawings depict example embodiments and are therefore not to be considered limiting of its scope.

### BRIEF DESCRIPTION OF THE DRAWINGS

The above and other aspects, features and advantages of certain embodiments of the present disclosure will be more apparent from the following detailed description, taken in conjunction with the accompanying drawings in which like characters represent like parts throughout the drawings, an in which:

FIG. 1A is a diagram illustrating an active noise control (ANC) system, in accordance with related art;

FIG. 1B is a diagram illustrating an example environment for an implementation of a system for ANC in an audio playback device, according to various embodiments;

FIG. 2 is a block diagram illustrating an example configuration of the system, according to various embodiments;

FIG. 3 is a block diagram illustrating example configurations of various modules of the system for the ANC in the audio playback device, according to various embodiments;

FIG. 4 is a flowchart illustrating an example method performed by a hybrid ANC filtering module, according to various embodiments;

FIG. 5 is a diagram illustrating an example method performed by a personalized in-ear module for estimating one or more ear canal parameters, according to various embodiments;

FIG. 6 is a diagram illustrating an example method performed by the personalized in-ear module for estimating the one or more ear canal parameters, according to various embodiments;

FIGS. 7A, 7B and 7C are flowcharts illustrating an example method for the ANC in the audio playback device, according to various embodiments;

FIG. 8 is a flowchart illustrating an example method for estimating the one or more ear canal parameters, according to various embodiments; and

FIGS. 9A, 9B and 9C are flowcharts illustrating an example method for estimating the one or more ear canal parameters, according to various embodiments.

Further, skilled artisans will appreciate that elements in the drawings are illustrated for simplicity and may not have necessarily been drawn to scale. For example, the flowcharts illustrate the method in terms of operations involved to help to improve understanding of aspects of the present disclosure. In terms of the construction of the device, one or more components of the device may have been represented in the drawings by conventional symbols, and the drawings may show those details that are pertinent to understanding the present disclosure so as not to obscure the drawings with details that will be readily apparent to those of ordinary skill in the art having the benefit of the description herein.

### DETAILED DESCRIPTION

Reference will now be made to various example embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory and are not intended to be restrictive thereof.

Whether a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more…” or “one or more elements is required.”

Reference is made herein to some or various “embodiments.” It should be understood that an embodiment is an example of a possible implementation of any features and/or elements of the present disclosure. Various embodiments have been described for the purpose of explaining one or more of the potential ways in which the specific features and/or elements of the disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Any features and/or elements described in the context of separate embodiments may alternatively be realized as existing together in the context of a single embodiment.

Any particular and all details set forth herein are used in the context of various embodiments and therefore should not necessarily be taken as limiting factors to the disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises... a” does not, without more constraints, preclude the existence of other devices or other sub-systems or other elements or other structures or other components or additional devices or additional sub-systems or additional elements or additional structures or additional components.

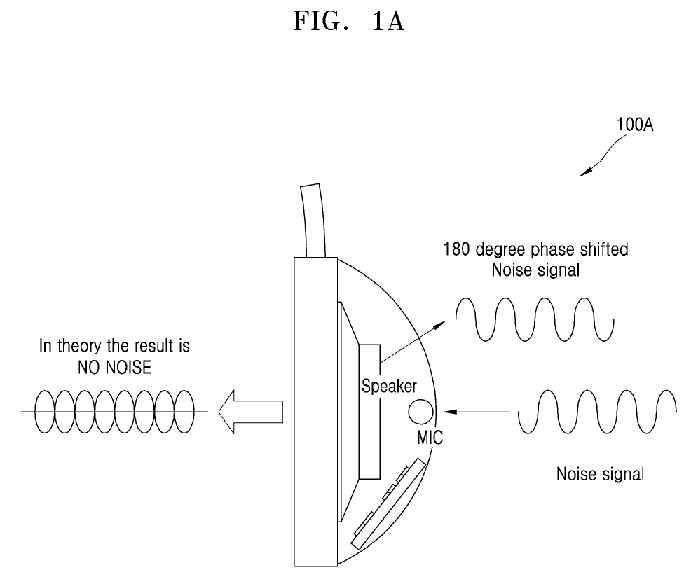

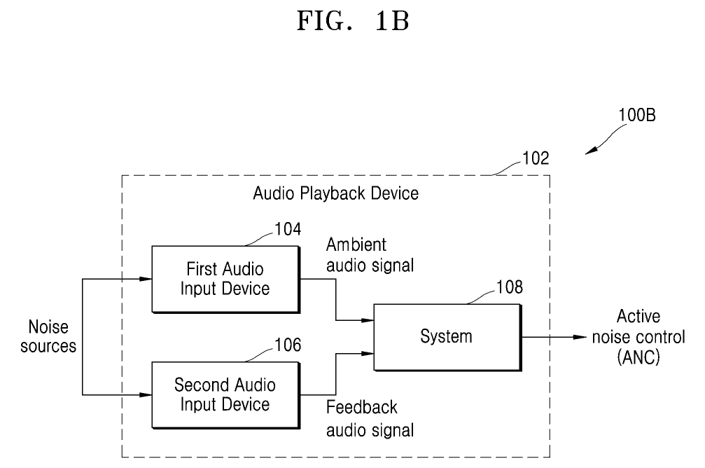

FIG. 1A illustrates an ANC system 100A, in accordance with related art. Among various ANC architectures, hybrid ANC systems, which utilize both feedforward and feedback microphones to cancel incoming noise, have gained popularity for superior performance across dynamic acoustic environments. As consumer demand for compact, high-performance audio devices continues to rise, True Wireless Stereo (TWS) earbuds have emerged as the leading preference of consumers in the hearables market. Further, the ANC is becoming the primary buying factor for the TWS earbuds. Modern ANC systems in TWS earbuds aim to provide not just noise suppression but also improved situational awareness, and enhanced productivity over the conventional earbud devices.

However, implementing high-performing ANC in the TWS earbuds presents several challenges. For instance, users expect robust ANC performance (> 35-40 dB) across diverse signals in several real-world noisy acoustic environments (for example, broadband, impulsive noise signals in workplace, home, during commute etc.) and across diverse user’s ear anatomies to be achieved with low-latency, low-power algorithms to preserve TWS battery life. Loose fitting between the TWS earbuds and user’s ear leads to noise leakage and thus, ANC performance degradation. Furthermore, the users prefer small and lightweight TWS earbuds, however, additional microphones, and processing hardware are often required for providing superior ANC capabilities. Additionally, the users increasingly expect personalized sound experiences, which require adaptive ANC systems capable of dynamically adjusting to individual preferences and contexts.

Most of the TWS earbuds feature adaptive hybrid ANC systems for improved performance in different noisy surroundings. In some commercial devices, existing adaptive ANC techniques detect and classify the environment, such as indoors/outdoors, or places such as gym, office, commute etc., and based on the user settings, allow the user to control the extent of cancellation provided by ANC. For example, in an outdoor environment, the user may keep the volume at 100%, whereas for an indoor environment, the volume may be at 70%. However, since the acoustic environments can be extremely diverse, there might be a need for manual tuning of gains, which can make the process very tedious and time-consuming for the users. Recent audio devices also introduce adaptive ANC and transparency modes, which allow switching between the ANC and the transparency mode. However, such applications are limited since they are designed to prevent/reduce harm to users, e.g., detecting alarm sounds, higher sound pressure levels, etc. Additionally, since it is not practically possible to place an error microphone at the eardrum of the user, the existing techniques utilize the feedback microphone as the error microphone, however, such techniques are complex, resource-intensive, and require manual inputs. Therefore, there exists a need for improved methods and systems to address the above-mentioned limitations.

The present disclosure relates to a method and a system for active noise control (ANC) in an audio playback device. For example, the present disclosure provides a personalized and fully adaptive low-complexity ANC technique with personalized ear canal modelling. For example, the present disclosure provides a low-complexity hybrid adaptive ANC technique with noise classification, block-based sub-band filtering, and adaptive gain computation, as explained in detail in the forthcoming paragraphs. The disclosed techniques are capable of detecting and adapting to varying acoustic environments, user’s voice and anatomy while reducing overall computational complexity. For example, the disclosed techniques are capable of effectively blocking out noise such as construction, traffic, etc., using ANC in different acoustic indoor and outdoor environments with robust cancellation for different user ear fittings.

FIG. 1B is a diagram illustrating an example environment 100B for an implementation of a system 108 for the ANC in an audio playback device 102, according to various embodiments.

In an embodiment, the environment 100B may include the audio playback device 102 placed in an acoustic environment having a plurality of noise sources such as traffic, human speech, and environmental sounds. An example of the audio playback device 102 may include, but is not limited to, True Wireless Stereo (TWS) earbuds. The audio playback device 102 may include a first audio input device 104, a second audio input device 106, and the system 108.

In an embodiment, the first audio input device 104 may include various circuitry and be positioned outwardly on the audio playback device 102 (e.g., outside an earbud). The first audio input device 104 may be configured to receive an ambient audio signal (for example, before the ambient audio signal reaches the entrance of ear canal of a user of the audio playback device 102). The ambient audio signal may be indicative of environmental noise around the audio playback device 102. For example, the ambient audio signal may be an acoustic summation of the plurality of noise sources present in the environment 100B. The first audio input device 104 may comprise a microphone to obtain the ambient audio signal. The first audio input device 104 may correspond to a feedforward microphone of the audio playback device 102.

In an embodiment, the second audio input device 106 may include various circuitry and be positioned inwardly on the audio playback device 102 (e.g., inside the earbud and typically near the entrance of ear canal of the user). The second audio input device 106 may be configured to receive a feedback audio signal. The feedback audio signal may indicate a residual audio signal received within the ear canal of the user of the audio playback device 102. The residual audio signal may include a combination of an input audio signal being played on the audio playback device 102 and residual environmental noise around the audio playback device 102. The second audio input device 106 may comprise a microphone to obtain the feedback audio signal. For example, the second audio input device 106 may correspond to a feedback microphone of the audio playback device 102. The second audio input device 106 may be configured to monitor the sound that enters the ear canal of the user, including any leaked noise signal.

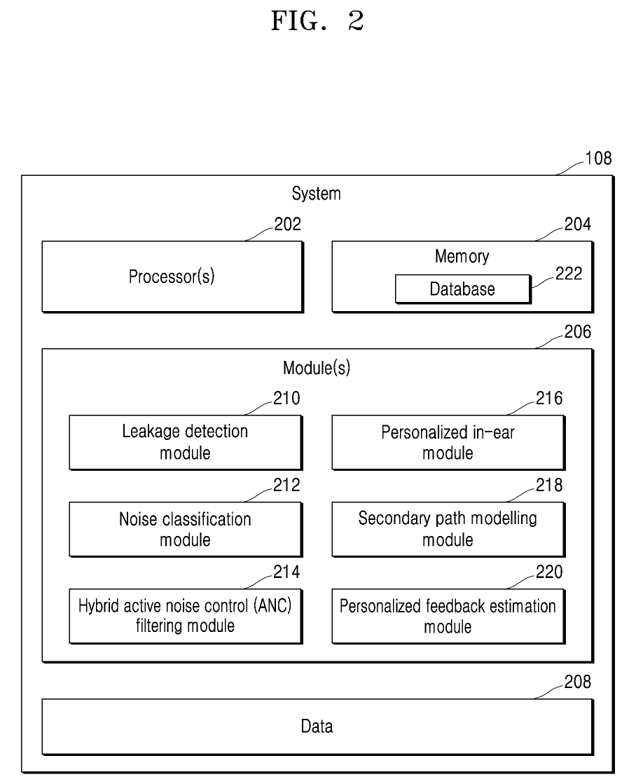

In an embodiment, the system 108 may be configured to receive the ambient audio signal and the feedback audio signal and provide the ANC in the audio playback device 102, as explained in greater detail below with reference to FIGS. 2 to 6.

FIG. 2 is a block diagram illustrating an example configuration of the system 108, according to various embodiments. The system 108 may include at least one processor (e.g., including processing circuitry) 202, a memory 204, one or more modules (e.g., including various circuitry and/or executable program instructions) 206, and data 208. In an embodiment, the system 108 may be implemented in the audio playback device 102.

In an example embodiment, the at least one processor 202 (hereinafter referred to as “processor 202”) may be operatively coupled to each of the memory 204, the one or more modules 206, and the data 208. The processor 202 may include various processing circuitry including Digital Signal Processors (DSPs), microcontrollers, or microprocessors. The processor 202 may execute a software program, such as code generated manually (e.g., programmed) to perform the desired operation. The processor 202 may implement various techniques such as, but not limited to, data extraction, Artificial Intelligence (AI), Machine Learning (ML), Deep Learning (DL), and so forth to achieve the desired objective. Thus, the processor 202 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

In an embodiment, the at least one processor 202 may be configured to receive, via the first audio input device 104 positioned outwardly on the audio playback device 102, the ambient audio signal. The first audio input device 104 may correspond to the feedforward microphone. The ambient audio signal may be indicative of the environmental noise around the audio playback device 102.

In an embodiment, the at least one processor 202 may be configured to receive, via the second audio input device 106 positioned inwardly on the audio playback device 102 (e.g., inside the earbud and typically near the entrance of ear canal of the user), the feedback audio signal. The second audio input device 106 may correspond to the feedback microphone. The feedback audio signal may indicate the residual audio signal received within the ear canal of the user of the audio playback device 102. The residual audio signal may include the combination of the input audio signal and the residual environmental noise around the audio playback device 102.

In an embodiment, the at least one processor 202 may be configured to determine an estimated leaked signal based on the ambient audio signal and the feedback audio signal. In an embodiment, to determine the estimated leaked signal, the at least one processor 202 may be configured to estimate a difference between power spectral density (PSD) of each of the ambient audio signal and the feedback audio signal.

In an embodiment, the at least one processor 202 may be configured to extract, from the ambient audio signal, an initial anti-noise audio signal corresponding to dominant noise sources within a plurality of sub-bands of the ambient audio signal. To extract the initial anti-noise audio signal, the at least one processor 202 may be configured to divide the ambient audio signal into the plurality of sub-bands. The at least one processor 202 may also be configured to identify the dominant noise source within each sub-band based on sub-band classification of the ambient audio signal. The at least one processor 202 may further be configured to extract, from the ambient signal, the initial anti-noise audio signal based on the identified dominant noise source. To extract the initial anti-noise signal, the at least one processor 202 may be configured to retrieve, from a database 222, a trained (e.g., pre-trained) feedforward control filter for each sub-band based on the identified dominant sound source. The at least one processor 202 may also be configured to determine a hybrid ANC filter for each sub-band based on the pre-trained feed forward control filter, a feedback filter, and a secondary path model output. The hybrid ANC filter may include a filter gain associated with each sub-band. The at least one processor 202 may further be configured to adapt the filter gain associated with each sub-band based on the identified dominant sound source and a detected sound level within each sub-band. The at least one processor 202 may be configured to extract, from the ambient signal, the initial anti-noise audio signal based on adapted filter gains for the plurality of sub-bands.

In an embodiment, the at least one processor 202 may be configured to estimate one or more ear canal parameters associated with the user of the audio playback device 102 based on the feedback audio signal, the estimated leaked signal, and the initial anti-noise audio signal. To estimate the one or more ear canal parameters, the at least one processor 202 may be configured to estimate the one or more ear canal parameters using a personalized in-ear machine learning (ML)-based model.

In an embodiment, to estimate the one or more ear canal parameters, the at least one processor 202 may be configured to select a virtual path, among a plurality of virtual paths pre-stored in the database 222, based on one or more dominant frequency features extracted from the estimated leaked signal. Each virtual path may indicate one or more acoustic characteristics corresponding to different ear fittings. The at least one processor 202 may also be configured to estimate the one or more ear canal parameters based on the selected virtual path.

In an embodiment, to estimate the one or more ear canal parameters, the at least one processor 202 may be configured to generate an estimated loudspeaker playback signal based on processing a media playback signal using a loudspeaker model. The at least one processor 202 may also be configured to generate a compensated feedback audio signal based on de-convolution of the feedback audio signal using the estimated loudspeaker playback signal and the estimated leaked signal. The at least one processor 202 may further be configured to estimate the one or more ear canal parameters based on the compensated feedback audio signal. Furthermore, to estimate the one or more ear canal parameters, the at least one processor 202 may be configured to transform the compensated feedback audio signal into a sub-band frequency domain compensated feedback audio signal. The at least one processor 202 may also be configured to determine a dominant frequency band within the sub-band frequency domain compensated feedback audio signal based on performing spectrum whitening on the sub-band frequency domain compensated feedback audio signal. The at least one processor 202 may further be configured to estimate the one or more ear canal parameters based on the determined dominant frequency band. To estimate the one or more ear canal parameters, the at least one processor 202 may be configured to select the virtual path, among the plurality of virtual paths pre-stored in the database 222, based on the determined dominant frequency band. Each virtual path may indicate one or more acoustic characteristics corresponding to different ear fittings. The at least one processor 202 may be configured to estimate the one or more ear canal parameters based on the selected virtual path.

In an embodiment, the at least one processor 202 may be configured to generate an anti-noise signal (e.g., a final anti-noise signal) for playback via the audio playback device 102 based on the one or more ear canal parameters to achieve the ANC at the audio playback device 102.

The memory 204 may be configured to store data and instructions executable by the processor 202. In an embodiment, the memory 204 may communicate via a bus within the system 108. The memory 204 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 204 may include a cache or random-access memory for the processor 202. In alternative examples, the memory 304 is separate from the processor 202, such as a cache memory of a processor, the system memory, or other memory. The memory 204 may include an external storage device or database for storing data. The memory 204 may be operable to store instructions executable by the processor 202. The functions, acts, or tasks illustrated in the figures or described may be performed by the programmed processor 202 for executing the instructions stored in the memory 204. The functions, acts, or tasks are independent of the particular type of instruction set, storage media, processor, or processing strategy and may be performed by software, hardware, integrated circuits, firmware, micro-code, and the like, operating alone or in combination. Processing strategies may include multiprocessing, multitasking, parallel processing, and the like. The memory 204 may further include a database 222 to store the data. The memory 204 may include an operating system for performing one or more tasks of the system 108, as performed by a generic operating system in the communications domain.

The one or more modules 206, amongst other things, may include routines, programs, objects, components, data structures, etc., which perform particular tasks or implement data types. The one or more modules 206 may also be implemented as, signal processor(s), state machine(s), logic circuitries, and/or any other device or component that manipulates signals based on operational instructions. Further, the one or more modules 206 can be implemented in hardware, instructions executed by a processing unit, or by a combination thereof. The processing unit can comprise a computer, the processor 202, a state machine, a logic array, or any other suitable devices capable of processing instructions. The processing unit can be a general-purpose processor that executes instructions to cause the general-purpose processor to perform the required tasks, or the processing unit can be dedicated to performing the required functions. In an embodiment of the present disclosure, the one or more modules 206 may be machine-readable instructions (software) which, when executed by a processor/processing unit, perform any of the described functionalities.

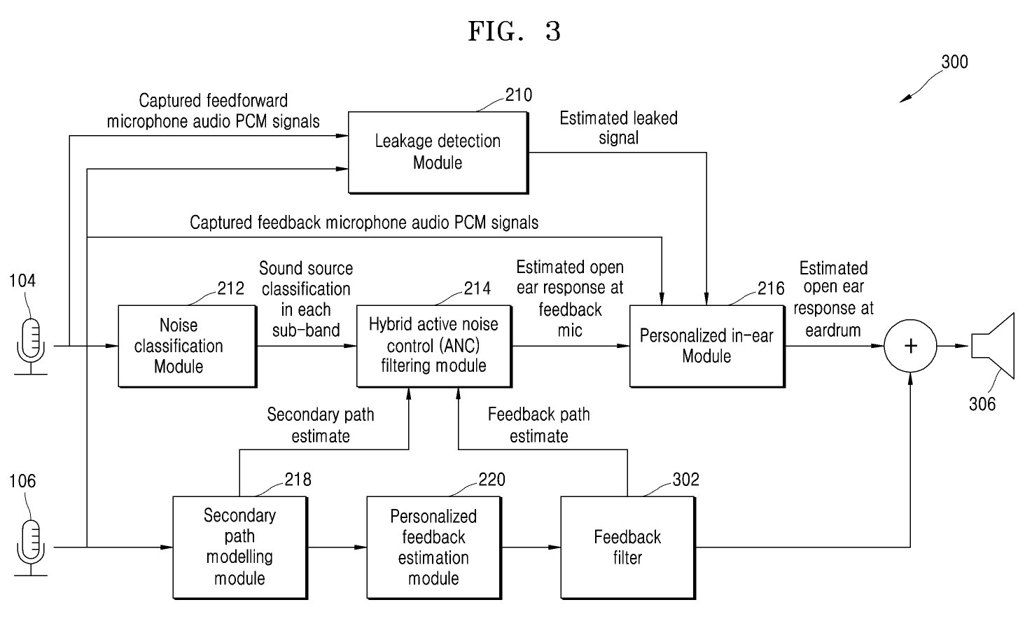

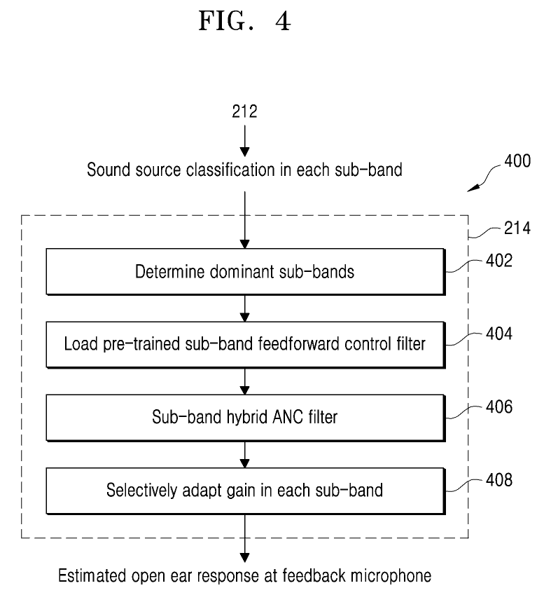

The one or more modules 206 may include a set of instructions that may be executed to cause the system 108 for the adaptive ANC in the audio playback device 102. The one or more modules 206 may include a leakage detection module 210, a noise classification module 212, a hybrid ANC filtering module 214, a personalized in-ear module 216, a secondary path modelling module 218, and a personalized feedback estimation module 220. In an embodiment, the leakage detection module 210, the noise classification module 212, the hybrid ANC filtering module 214, the personalized in-ear module 216, the secondary path modelling module 218, and the personalized feedback estimation module 220 may be in communication with each other. Various operations performed by each of the one or more modules 206 in communication with each other are described in in greater detail below with reference to FIGS. 3 and 4.

In an embodiment, the data 208 may serve, amongst other things, as a repository for storing data processed, received, and generated by the one or more modules 206.

FIG. 3 is a block diagram illustrating the one or more modules 206 of the system 108 for the ANC in the audio playback device 102, according to various embodiments. The one or more modules 206 may include the one or more instructions that may be executed to cause the system 108, and in particular, the at least one processor 202 of the system 108, to achieve the ANC in the audio playback device 102.

In an embodiment, the leakage detection module 210 may be configured to determine the estimated leaked signal based on the ambient audio signal and the feedback audio signal. The ambient audio signal may be received via the first audio input device 104 positioned outwardly on the audio playback device 102. The ambient audio signal may be indicative of the environmental noise around the audio playback device. For example, the ambient audio signal may include one or more audio pulse code modulation (PCM) signals captured by the feedforward microphone of the audio playback device 102. the feedback audio signal may be received via the second audio input device 106 positioned inwardly on the audio playback device 102. The feedback audio signal may indicate the residual audio signal received within the ear canal of the user of the audio playback device 102. The residual audio signal may include the combination of the input audio signal and the residual environmental noise around the audio playback device 102. For example, the feedback audio signal may include one or more audio PCM signals captured by the feedback microphone of the audio playback device 102. The estimated leaked signal may be indicative of an audio leakage from the audio playback device 102, e.g., the estimated leaked signal may indicate an amount of the environmental noise leaking into the ear canal of the user. In an embodiment, the audio playback device 102 may be customized using the estimated leaked signal to obtain the personalized in-ear model. The estimated leaked signal used to obtain personalized in-ear model may include an acoustic path between the eardrum and the feedback microphone. The estimated leaked signal may be determined as a measure of the power difference between the ambient audio signal and the feedback audio signal. In an embodiment, to determine the estimated leaked signal, the leakage detection module 210 may be configured to estimate the difference between the PSD of each of the ambient audio signal and the feedback audio signal. The PSD may refer to a measure of power content of a signal versus frequency. The determined estimated leaked signal may be passed to the personalized in-ear module 216 for further processing, as explained in greater detail below.

In an embodiment, the noise classification module 212 may be configured to receive the ambient audio signal from the first audio input device 104. The noise classification module 212 may also be configured to divide the ambient audio signal into the plurality of sub-bands. The noise classification module 212 may further be configured to classify types of noises (e.g., broadband (BB), impulsive (Imp), narrowband (NB), or quiet) within each sub-band based on sub-band classification of the ambient audio signal. For example, the noise classification module 212 may be configured to perform sound source classification in each sub-band. The noise classification module 212 may be a sub-band block-based noise classifier configured to analyze one or more frequency components in the sub-bands and process the one or more frequency components in blocks. In an embodiment, the noise classification module 212 may utilize one or more neural networks (NNs) to identify the dominant noise source within each sub-band. In an embodiment, the noise classification module 212 may utilize digital signal processing (DSP) to identify the dominant noise source within each sub-band.

In an embodiment, the hybrid ANC filtering module 214 may be configured to extract, from the ambient audio signal, the initial anti-noise audio signal (also referred to as a preliminary anti-noise audio signal) corresponding to the dominant noise sources within the plurality of sub-bands of the ambient audio signal. The initial anti-noise signal may correspond to an estimated open ear response at the second audio input device 106 (e.g., the feedback microphone). Functions of the hybrid ANC filtering module 214 (along with processing of signals received from the modules 206) are explained in greater detail below with reference to FIG. 4.

FIG. 4 is a flowchart illustrating an example method 400 performed by the hybrid ANC filtering module 214, according to various embodiments.

As shown in FIG. 4, the hybrid ANC filtering module 214 may receive the sound source classification in each sub-band from the noise classification module 212.

At step 402, the hybrid ANC filtering module 214 may be configured to identify the dominant noise source within each sub-band based on the sub-band classification of the ambient audio signal obtained from noise classification module 212. The hybrid ANC filtering module 214 may be configured to extract, from the ambient signal, the initial anti-noise audio signal based on the identified dominant noise source, as explained in greater detail below. In an embodiment, sub-band filtering may utilize a perfect reconstruction and delayless approach to minimize/reduce latency and audio artifacts in low-complexity applications. In an embodiment, perceptual filterbanks (such as the gammatone filterbank) may be used to enhance perceptual performance when additional computational resources are available and higher quality is desired.

At step 404, the hybrid ANC filtering module 214 may be configured to retrieve, from the database 222, the pre-trained feedforward control filter for each sub-band based on the identified dominant sound source. The retrieval of the pre-trained feedforward control filter may also be based on the sub-band classification. Further, the database 222 may be located in the memory 204. The pre-trained feedforward control filter may be stored either as one or more filter coefficients (e.g., an 8-bit signed integer (INT8) format or a 16-bit signed integer (INT16) format to save storage space) or as one or more filter parameters (such as quality factor, gain, and center frequency).

At step 406, the hybrid ANC filtering module 214 may be configured to determine the hybrid ANC filter for each sub-band based on the pre-trained feedforward control filter, the feedback filter 302, and the secondary path model output (e.g., a secondary path estimate from the secondary path modelling module 218). For example, the hybrid ANC filtering module 214 may be configured to combine the retrieved pre-trained feedforward control filter with the output of feedback filtering module 302 (e.g. the feedback path estimate), and an output of the secondary path modelling module 218 (e.g., the secondary path estimate) to determine the hybrid ANC filter for each sub-band. The secondary path estimate may be used to optimize the hybrid ANC filter. The secondary path modelling module 218 may be configured to model an acoustic transfer function (e.g., the secondary path estimate) between a speaker 306 of the audio playback device 102 and the second audio input device 106. Additionally, the personalized feedback estimation module 220 may be configured to estimate a user-specific feedback path, representing an acoustic leakage of a speaker signal back into the second audio input device 106, based on estimated individual anatomical characteristics (e.g., ear canal geometry). The feedback filter 302 may be configured to cancel unwanted feedback signals between the speaker 306 of the audio playback device 102 and the second audio input device 106 (e.g., the feedback microphone) using the estimated user-specific feedback path. The hybrid ANC filter may include the filter gain associated with each sub-band. The filter gain may refer to an amplitude scaling factor applied to an output of a filter or a filter section.

At step 408, the hybrid ANC filtering module 214 may be configured to adapt the filter gain associated with each sub-band based on the identified dominant sound source and the detected sound level within each sub-band. For example, the hybrid ANC filtering module 214 may be configured to selectively adapt the filter gain corresponding only to the hybrid ANC filter in each sub-band in real-time, thereby facilitating a robust and low-complexity adaptive ANC. Moreover, the hybrid ANC filtering module 214 may be configured to extract, from the ambient signal, the initial anti-noise audio signal based on the adapted filter gains for the plurality of sub-bands.

The present disclosure may utilize a block-based hybrid ANC approach that only adapts gains in different sub-bands for pre-computed filters according to incoming noise types based on noise classification output. By adapting only gain values instead of the filter coefficients, the present disclosure reduces overall latency and computational complexity of the system.

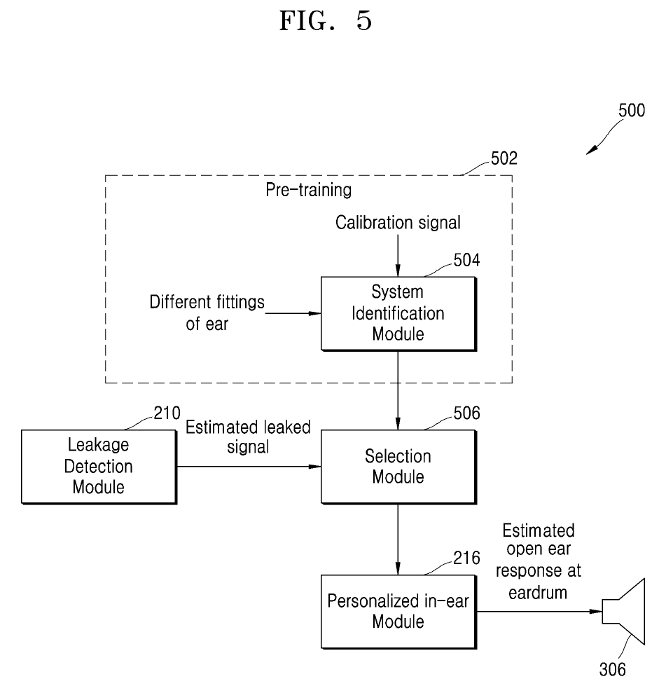

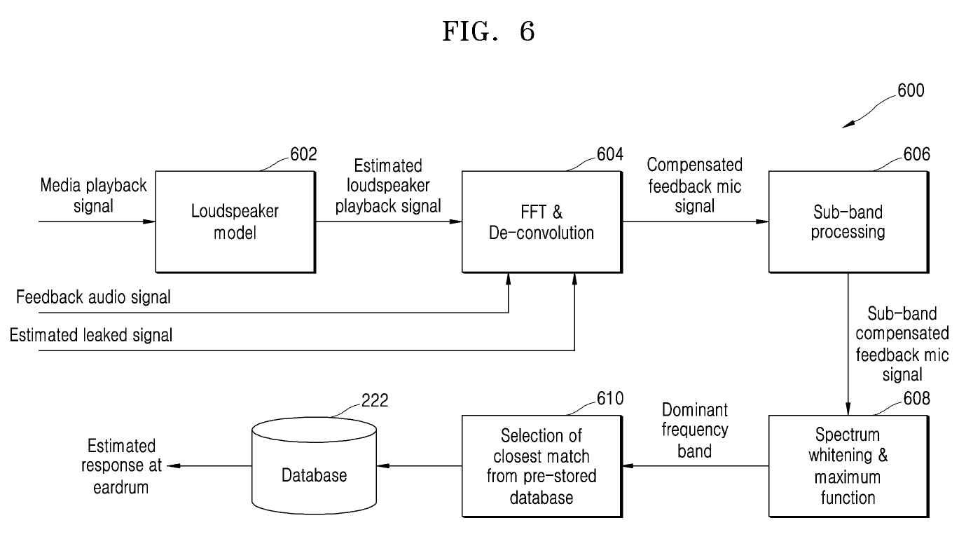

Referring to FIG. 3, in an embodiment, the personalized in-ear module 216 may be configured to estimate the one or more ear canal parameters associated with the user of the audio playback device 102 based on the feedback audio signal, the estimated leaked signal, and the initial anti-noise audio signal. The one or more ear canal parameters may refer to physical and acoustic characteristics of the user’s ear canal that influence the way sound waves travel from the outer ear to the eardrum. Examples of the one or more ear canal parameters may include, but are not limited to, ear canal length, diameter or cross-sectional area of the ear canal, shape and curvature of the ear canal, etc. The personalized in-ear module 216 may correspond to the personalized in-ear model. The personalized in-ear may be a trained (e.g., pre-trained) model. Estimation of the one or more ear canal parameters by the personalized in-ear module 216 is explained in greater detail below with reference to FIGS. 5 and 6.

FIG. 5 is a diagram illustrating an example method 500 performed by the personalized in-ear module 216 for estimating the one or more ear canal parameters, according to various embodiments.

In an embodiment, noise reduction performance may typically be evaluated at the feedback microphone, as it is not feasible to place an error microphone at the eardrum. A mismatch between frequency responses at the eardrum and feedback microphone position may lead to degradation of ANC performance for feedback and hybrid ANC methods even for optimal controllers. Thus, the present disclosure utilizes a virtual sensing technique to estimate an open ear response at the eardrum (e.g., an actual sound heard by the user) based on the initial anti-noise signal, the estimated leaked signal, and the feedback audio signal received at the second audio input device 106. The estimation of the open ear response at the eardrum is achieved using a virtual path or an ear canal path of the user, as explained in detail in the forthcoming paragraphs.

Referring to FIG. 5, during a pre-training phase 502, a system identification module 504 may receive a calibration signal and information associated with different fittings of the user. Based on the calibration signal and the information associated with different fittings of the user, the system identification module 504 may be configured to estimate the plurality of virtual paths (or, impulse responses) from the speaker 306 of the audio playback device 102 to the second audio input device 106 (e.g., the feedback microphone) for the different fittings. Each of the plurality of virtual paths may indicate one or more acoustic characteristics (e.g., individual ear geometry and sealing) corresponding to the different ear fittings. The plurality of virtual paths may be pre-trained offline using, for example, ear simulators or dummy head setups. The system identification module 504 may be configured to utilize shallow Long Short-Term Memory (LSTM)-based models for audio playback devices with higher computational capability to provide high quality estimation and DSP-based techniques for resource constrained audio playback devices. The calibration signal may be a test signal played during one-time calibration. The calibration signal may be used to excite the system 108 and allow estimation of the way sound propagates through the ear canal of the user. An example of the calibration signal may include, but is not limited to, a white noise signal played through the speaker 306 (or a transducer) and recorded at the second audio input device 106. The information associated with the different fittings of the user may include different earbud insertion styles (for example, deep, shallow, loose, tight, etc.). The different fittings may affect the acoustic path from the speaker 306 to the second audio input device 106, and finally, the sound heard at the eardrum. Each of the different fittings may alter the impulse response (IR) of the acoustic path. In an embodiment, following the estimation, the plurality of virtual paths may be pre-stored in the database 222 located in the memory 204.

In an embodiment, the selection module 506 may be configured to select a virtual path, among the plurality of virtual paths pre-stored in the database 222, based on one or more dominant frequency features extracted from the estimated leaked signal determined by the leakage detection module 210. The one or more dominant frequency features may include, but are not limited to, frequencies with highest power in a frequency band. Some additional band specific frequencies such as, peak frequency, centre frequencies, harmonics, and other fundamental frequencies may also be considered for better modelling. The extracted one or more dominant frequency features and corresponding virtual paths (e.g., the IRs) may be stored in a personalized database 222 (e.g., located in the memory 204) for the different fittings. The size of dataset being stored may vary based on precision of the IRs and corresponding ear canal length. For example, the IR as data and common ear canal length as key values at fixed intervals may be stored in the database 222 or a data structure. To store impulse response data of length 128 samples at 16 kHz sampling rate with ear canal lengths within range of 23mm to 29mm, each impulse response may require 256 bytes of memory. Ten different impulse responses (for instance, from 23mm to 29mm in steps of 0.6mm) and corresponding 10 ear canal length values may be stored, which may require about 2.5 kB memory. Depending on memory resources of the audio playback device 102, the impulse responses for multiple ear canal lengths with coarser or finer resolution may be stored on-device. In an embodiment, the system identification module 504 and the selection module 506 may also be a part of the one or more modules 206.

In an embodiment, the personalized in-ear module 216 may be configured to estimate the one or more ear canal parameters based on the selected virtual path. Further, the personalized in-ear module 216 may be configured to estimate the open ear response at the eardrum based on the one or more ear canal parameters.

FIG. 6 is a diagram illustrating an example method 600 performed by the personalized in-ear module 216 for estimating the one or more ear canal parameters, according to various embodiments. The method 600 corresponds to a personalized in-ear virtual sensing method based on low-complex DSP techniques. The method 600 may be implemented by the system 108, for example, the at least one processor 202 of the system.

Playing of the calibration signal may not always be feasible. For example, the user may be streaming music or on a call and may not want playback interrupted for calibration. Thus, the present disclosure utilizes a media playback signal (e.g., the input signal already being played) captured at the second audio input device 106 (e.g., the feedback microphone) to estimate an in-ear transfer function. The in-ear transfer function may be estimated based on the feedback audio signal, the estimated leaked signal, and the media playback signal. The media playback signal may correspond to an audio signal before being sent to a loudspeaker for playback.

The method 600 may include pre-processing the feedback audio signal using a pre-computed inverse filter to eliminate effects of microphone response (e.g., distortion) on the feedback audio signal. The pre-computed inverse filter may be pre-computed using inverse filtering which include digital filter design allowing selective attenuation of unwanted peaks using one or more known techniques, such as frequency dependent regularization and least square method to estimate the effect of microphone. Since these techniques are well-known, these are not explained in detail for the sake of brevity.

At step 602, the method 600 may include generating the estimated loudspeaker playback signal based on processing the media playback signal using the loudspeaker model. The loudspeaker model may correspond to a DSP-based or an ML-based model configured to simulate a behaviour of a loudspeaker in response to the media playback signal.

At step 604, the method 600 may include generating the compensated feedback audio signal based on de-convolution of the feedback audio signal (e.g., the pre-processed feedback audio signal) using the estimated loudspeaker playback signal and the estimated leaked signal.

At step 606, the method 600 may include transforming the compensated feedback audio signal into the sub-band frequency domain compensated feedback audio signal.

At step 608, the method 600 may include determining the dominant frequency band within the sub-band frequency domain compensated feedback audio signal based on performing spectrum whitening on the sub-band frequency domain compensated feedback audio signal. The dominant frequency band may correspond to a frequency band with the highest power, which may correspond to the most informative band for characterizing the ear response. The spectrum whitening may be performed to remove any bias in frequency component of the sub-band frequency domain compensated feedback audio signal.

At step 610, the method 600 may include selecting the virtual path, among the plurality of virtual paths (or the impulse responses) pre-stored in the database 222, based on the determined dominant frequency band. Each virtual path may indicate the one or more acoustic characteristics corresponding to the different ear fittings. The database 222 may be located in the memory 204.

The method 600 may also include estimating the one or more ear canal parameters based on the selected virtual path, thus, outputting the estimated ear canal response. For example, the method 600 provides the best matched estimate of the ear canal’s transfer function based on the pre-stored impulse responses for various ear canal profiles. Thus, the present disclosure provides a low-complex DSP-based approach for estimating in-ear response without using test signals.

Referring to FIG. 3, in an embodiment, the personalized in-ear module 216 may be configured to generate the anti-noise signal (e.g., the final anti-noise signal) for playback via the audio playback device 102 based on the one or more ear canal parameters to achieve the ANC at the audio playback device 102. The final anti-noise signal may correspond to the estimated open ear response at the eardrum of the user. The final anti-noise signal may be played via the speaker 306 of the audio playback device 102.

The present disclosure provides an end-to-end approach for hybrid ANC based on adapting gains for the hybrid ANC filter together with the personalized in-ear modelling. A block based sub-band hybrid ANC solution with integrated leakage estimation and in-ear modelling provides a robust noise cancellation for different acoustic environments and different users.

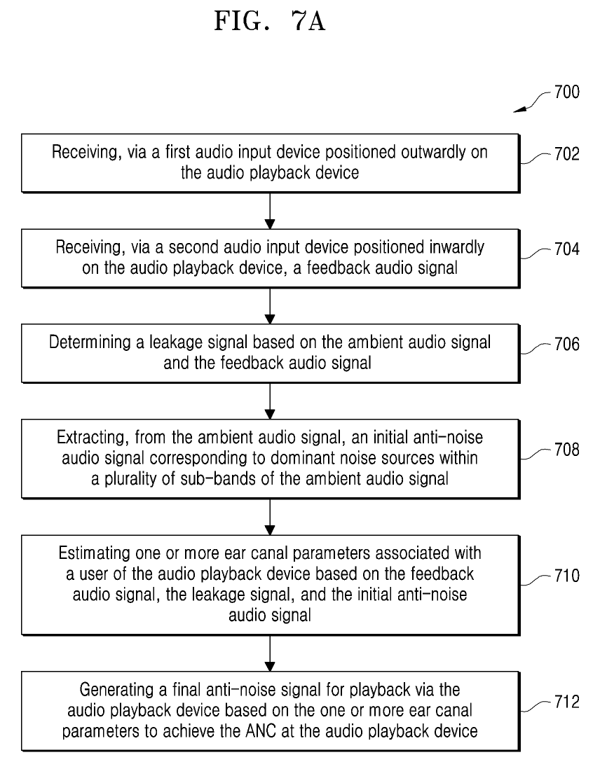

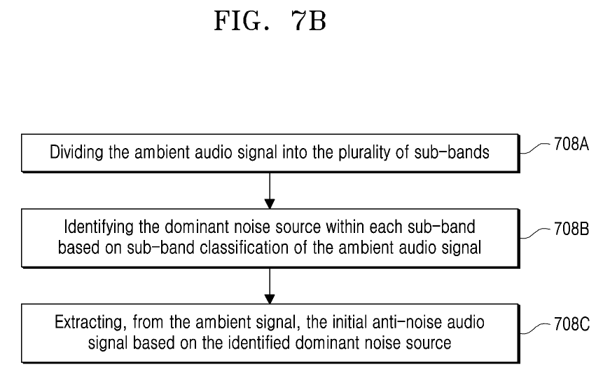

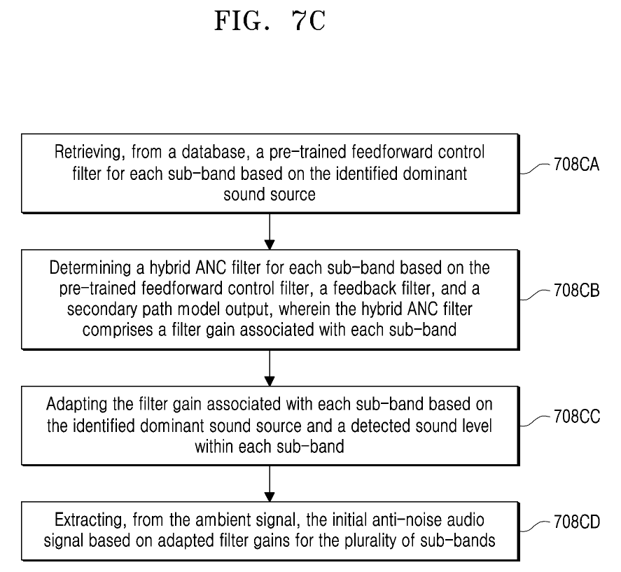

FIGS. 7A, 7B and 7C are flowcharts illustrating an example method 700 for the ANC in the audio playback device 102, according to various embodiments. The method 700 may be a computer-implemented method executed by the system 108, and For example, by the processor 202 and/or the module(s) 206 of the system 108.

Referring to FIG. 7A, at step 702, the method 700 may include receiving, via the first audio input device 104 positioned outwardly on the audio playback device 102, an ambient audio signal. The ambient audio signal may be indicative of the environmental noise around the audio playback device 102. In an embodiment, the first audio input device 104 may correspond to the feedforward microphone.

At step 704, the method 700 may include receiving, via the second audio input device 106 positioned inwardly on the audio playback device 102 (e.g., inside the earbud and typically near the entrance of ear canal of the user), a feedback audio signal. The feedback audio signal may indicate the residual audio signal received within the ear canal of the user of the audio playback device 102. The residual audio signal may include a combination of an input audio signal and residual environmental noise around the audio playback device. In an embodiment, the second audio input device 106 may correspond to the feedback microphone.

At step 706, the method 700 may include determining the estimated leaked signal based on the ambient audio signal and the feedback audio signal. In an embodiment, for determining the estimated leaked signal, the method 700 may include estimating the difference between the PSD of each of the ambient audio signal and the feedback audio signal.

At step 708, the method 700 may include extracting, from the ambient audio signal, the initial anti-noise audio signal corresponding to the dominant noise sources within the plurality of sub-bands of the ambient audio signal. Step 708 is explained in greater detail below with reference to FIGS. 7B and 7C.

Referring to FIG. 7B, in an embodiment, for extracting the initial anti-noise audio signal, at step 708A, the method 700 may include dividing the ambient audio signal into the plurality of sub-bands. At step 708B, the method 700 may include identifying the dominant noise source within each sub-band based on the sub-band classification of the ambient audio signal. At step 708C, the method 700 may include extracting, from the ambient signal, the initial anti-noise audio signal based on the identified dominant noise source.

Referring to FIG. 7C, in an embodiment, for extracting the initial anti-noise audio signal based on the identified dominant noise source, at step 708CA, the method 700 may include retrieving, from the database 222, the pre-trained feedforward control filter for each sub-band based on the identified dominant sound source. At step 708CB, the method 700 may include determining the hybrid ANC filter for each sub-band based on the pre-trained feedforward control filter, the feedback filter, and the secondary path model output. The hybrid ANC filter may include the filter gain associated with each sub-band. At step 708CC, the method 700 may include adapting the filter gain associated with each sub-band based on the identified dominant sound source and the detected sound level within each sub-band. At step 700CD, the method 700 may include extracting, from the ambient signal, the initial anti-noise audio signal based on the adapted filter gains for the plurality of sub-bands.

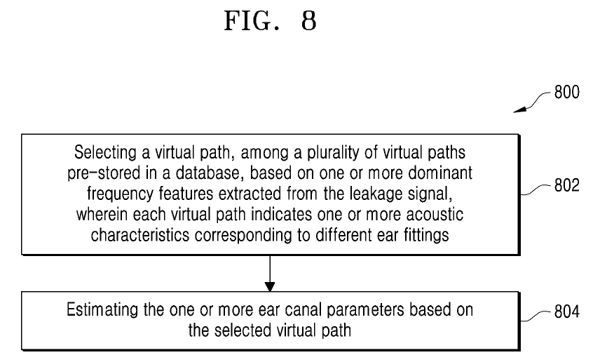

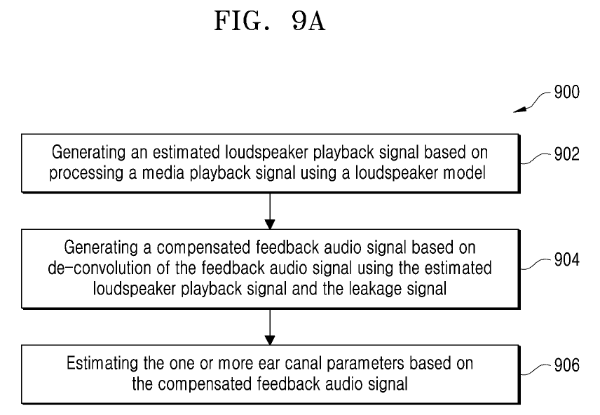

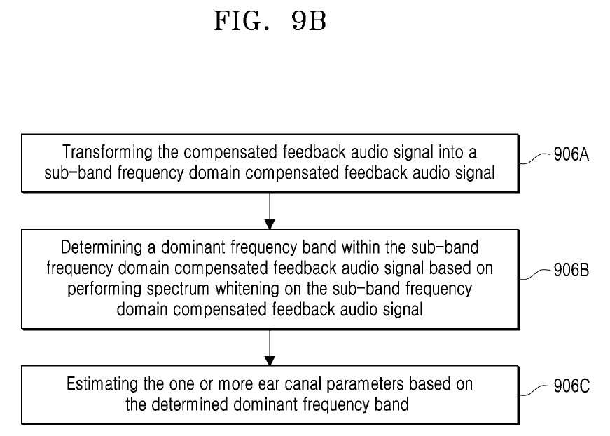

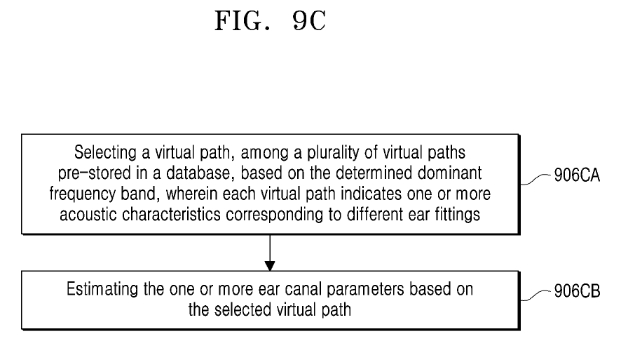

Referring back to FIG. 7A, at step 710, the method 700 may include estimating the one or more ear canal parameters associated with the user based on the feedback audio signal, the estimated leaked signal, and the initial anti-noise audio signal. In an embodiment, for estimating the one or more ear canal parameters, the method 700 may include estimating the one or more ear canal parameters using the personalized in-ear model. Step 710 is explained in greater detail below with reference to FIGS. 8 and 9A, 9B and 9C.

At step 712, the method 700 may include generating the final anti-noise signal for playback via the audio playback device 102 based on the one or more ear canal parameters to achieve the adaptive ANC at the audio playback device 102.

FIG. 8 is a flowchart illustrating an example method 800 for estimating the one or more ear canal parameters, according to various embodiments.

At step 802, the method 800 may include selecting the virtual path, among the plurality of virtual paths pre-stored in the database 222, based on the one or more dominant frequency features extracted from the estimated leaked signal. Each virtual path may indicate the one or more acoustic characteristics corresponding to the different ear fittings.

At step 804, the method 800 may include estimating the one or more ear canal parameters based on the selected virtual path.

FIGS. 9A, 9B and 9C are flowcharts illustrating an example method 900 for estimating the one or more ear canal parameters, according to various embodiments.

Referring to FIG. 9A, at step 902, the method 900 may include generating the estimated loudspeaker playback signal based on processing the media playback signal using the loudspeaker model.

At step 904, the method 900 may include generating the compensated feedback audio signal based on the de-convolution of the feedback audio signal using the estimated loudspeaker playback signal and the estimated leaked signal.

At step 906, the method 900 may include estimating the one or more ear canal parameters based on the compensated feedback audio signal. Step 906 is explained in greater detail below with reference to FIG. 9B.

Referring to FIG. 9B, in an embodiment, for estimating the one or more ear canal parameters, at step 906A, the method 900 may include transforming the compensated feedback audio signal into the sub-band frequency domain compensated feedback audio signal. At step 906B, the method 900 may include determining the dominant frequency band within the sub-band frequency domain compensated feedback audio signal based on performing the spectrum whitening on the sub-band frequency domain compensated feedback audio signal. At step 906C, the method 900 may include estimating the one or more ear canal parameters based on the determined dominant frequency band. The step 906C is explained in greater detail below with reference to FIG. 9C.

Referring to FIG. 9C, for estimating the one or more ear canal parameters, at step 900CA, the method 900 may include selecting the virtual path, among the plurality of virtual paths pre-stored in the database 222, based on the determined dominant frequency band. Each virtual path may indicate the one or more acoustic characteristics corresponding to the different ear fittings. At step 900CB, the method 900 may include estimating the one or more ear canal parameters based on the selected virtual path.

The present disclosure provides various advantages. For example, the present disclosure utilizes personalized in-ear modelling approaches based on low-complex ML and DSP to improve ANC performance. The present disclosure provides a low-complexity hybrid adaptive ANC technique with noise classification, block-based sub-band filtering, and adaptive gain computation. The disclosed technique enables detection and adaptation to varying acoustic environments, user’s anatomy while reducing overall computational complexity. For example, the block-based sub-band adaptive gain computation integrated with sub-band noise classification ensures low-latency and high-quality ANC output. The present disclosure improves call clarity in noisy surroundings, allowing the users to enjoy high-fidelity immersive playback for multimedia such as movies, music, enhancing the listening comfort of the users, and promoting work productivity in noisy surroundings such as busy cafes, open plan offices, etc.

The disclosed techniques provide a seamless experience to the users where the ANC filter automatically adjusts to the existing acoustic environment without the need for manual tuning or presets. For example, when a user goes out of their home onto a street, the disclosed techniques automatically adjust the ANC filter gains to reduce the ambient noise, and enable the user to listen to desired audio media such as music, movies or calls at low volume, thereby enhancing user comfort and protecting user’s hearing. The present disclosure also incorporates the user’s ear canal features, providing a similar robust ANC experience to all users and eliminating the needs for manual or application-based fit checks. For example, different users can wear the buds in any way in their ears based on their comfort, and the present disclosure ensures similar performance for different users and fittings. The present disclosure eliminates the need for the users to check to ensure tight fitting using the mobile application or manually adjust fit to get the best performance.

Moreover, the present disclosure provides a low-latency adaptive ANC and personalization which in turn provides seamless experience to the user. The present disclosure reduces model complexities, thereby preserving TWS battery life. Additionally, the disclosed techniques can be adapted for different form-factor headphones, personal amplification devices and applications, etc., thereby providing a flexible technique for adaptive ANC.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A method for active noise control (ANC) in an audio playback device, the method comprising:
receiving, via a first audio input device positioned outwardly on the audio playback device, an ambient audio signal;
receiving, via a second audio input device positioned inwardly on the audio playback device, a feedback audio signal;
determining an estimated leaked signal based on the ambient audio signal and the feedback audio signal;
extracting, from the ambient audio signal, an initial anti-noise audio signal corresponding to dominant noise sources within a plurality of sub-bands of the ambient audio signal;
estimating one or more ear canal parameters associated with a user of the audio playback device based on the feedback audio signal, the estimated leaked signal, and the initial anti-noise audio signal; and
generating an anti-noise signal for playback via the audio playback device based on the one or more ear canal parameters to achieve the ANC at the audio playback device.

2. The method as claimed in claim 1, wherein determining the estimated leaked signal comprises estimating a difference between power spectral density (PSD) of each of the ambient audio signal and the feedback audio signal.

3. The method as claimed in claim 1, wherein extracting the initial anti-noise audio signal comprises:
dividing the ambient audio signal into the plurality of sub-bands;
identifying the dominant noise source within each sub-band based on sub-band classification of the ambient audio signal; and
extracting, from the ambient signal, the initial anti-noise audio signal based on the identified dominant noise source.

4. The method as claimed in claim 3, wherein extracting the initial anti-noise signal comprises:
retrieving, from a database, a trained feedforward control filter for each sub-band based on the identified dominant sound source;
determining a hybrid ANC filter for each sub-band based on the trained feedforward control filter, a feedback filter, and a secondary path model output, wherein the hybrid ANC filter comprises a filter gain associated with each sub-band;
adapting the filter gain associated with each sub-band based on the identified dominant sound source and a detected sound level within each sub-band; and
extracting, from the ambient signal, the initial anti-noise audio signal based on adapted filter gains for the plurality of sub-bands.

5. The method as claimed in claim 1, wherein estimating the one or more ear canal parameters comprises:
estimating the one or more ear canal parameters using a personalized in-ear models.

6. The method as claimed in claim 1, wherein estimating the one or more ear canal parameters comprises:
selecting a virtual path, among a plurality of virtual paths stored in a database, based on one or more dominant frequency features extracted from the estimated leaked signal, wherein each virtual path indicates one or more acoustic characteristics corresponding to different ear fittings; and
estimating the one or more ear canal parameters based on the selected virtual path.

7. The method as claimed in claim 1, wherein estimating the one or more ear canal parameters comprises:
generating an estimated loudspeaker playback signal based on processing a media playback signal using a loudspeaker model;
generating a compensated feedback audio signal based on de-convolution of the feedback audio signal using the estimated loudspeaker playback signal and the estimated leaked signal;
estimating the one or more ear canal parameters based on the compensated feedback audio signal.

8. The method as claimed in claim 7, wherein estimating the one or more ear canal parameters comprises:
transforming the compensated feedback audio signal into a sub-band frequency domain compensated feedback audio signal;
determining a dominant frequency band within the sub-band frequency domain compensated feedback audio signal based on performing spectrum whitening on the sub-band frequency domain compensated feedback audio signal; and
estimating the one or more ear canal parameters based on the determined dominant frequency band.

9. The method as claimed in claim 8, wherein estimating the one or more ear canal parameters comprises:
selecting a virtual path, among a plurality of virtual paths stored in a database, based on the determined dominant frequency band, wherein each virtual path indicates one or more acoustic characteristics corresponding to different ear fittings; and
estimating the one or more ear canal parameters based on the selected virtual path.

10. The method as claimed in claim 1, wherein the first audio input device corresponds to a feedforward microphone, and the second audio input device corresponds to a feedback microphone.

11. The method as claimed in claim 1, wherein the ambient audio signal is indicative of environmental noise around the audio playback device, and wherein the feedback audio signal indicates a residual audio signal received within an ear canal of the user of the audio playback device, and wherein the residual audio signal comprises a combination of an input audio signal and residual environmental noise around the audio playback device.

12. A system for active noise control (ANC) in an audio playback device, the system comprising:
a memory;
at least one processor, comprising processing circuitry, communicatively coupled to the memory, wherein at least one processor, individually and/or collectively, is configured to cause the system to:
receive, via a first audio input device, comprising a microphone, positioned outwardly on the audio playback device, an ambient audio signal;
receive, via a second audio input device comprising a microphone positioned inwardly on the audio playback device, a feedback audio signal;
determine an estimated leaked signal based on the ambient audio signal and the feedback audio signal;
extract, from the ambient audio signal, an initial anti-noise audio signal corresponding to dominant noise sources within a plurality of sub-bands of the ambient audio signal;
estimate one or more ear canal parameters associated with a user of the audio playback device based on the feedback audio signal, the estimated leaked signal, and the initial anti-noise audio signal; and
generate an anti-noise signal for playback via the audio playback device based on the one or more ear canal parameters to achieve the ANC at the audio playback device.

13. The system as claimed in claim 12, wherein to determine the estimated leaked signal, at least one processor, individually and/or collectively, is configured to cause the system to estimate a difference between power spectral density (PSD) of each of the ambient audio signal and the feedback audio signal.

14. The system as claimed in claim 12, wherein to extract the initial anti-noise audio signal, at least one processor, individually and/or collectively, is configured to cause the system to:
divide the ambient audio signal into the plurality of sub-bands;
identify the dominant noise source within each sub-band based on sub-band classification of the ambient audio signal; and
extract, from the ambient signal, the initial anti-noise audio signal based on the identified dominant noise source.

15. The system as claimed in claim 14, wherein to extract the initial anti-noise signal, at least one processor, individually and/or collectively, is configured to cause the system to:
retrieve, from a database, a trained feedforward control filter for each sub-band based on the identified dominant sound source;
determine a hybrid ANC filter for each sub-band based on the trained feedforward control filter, a feedback filter, and a secondary path model output, wherein the hybrid ANC filter comprises a filter gain associated with each sub-band;
adapt the filter gain associated with each sub-band based on the identified dominant sound source and a detected sound level within each sub-band; and
extract, from the ambient signal, the initial anti-noise audio signal based on adapted filter gains for the plurality of sub-bands.

16. The system as claimed in claim 12, wherein to estimate the one or more ear canal parameters, at least one processor, individually and/or collectively, is configured to cause the system to:
estimate the one or more ear canal parameters using a personalized in-ear model.

17. The system as claimed in claim 12, wherein to estimate the one or more ear canal parameters, at least one processor, individually and/or collectively, is configured to cause the system to:
select a virtual path, among a plurality of virtual paths stored in a database, based on one or more dominant frequency features extracted from the estimated leaked signal, wherein each virtual path indicates one or more acoustic characteristics corresponding to different ear fittings; and
estimate the one or more ear canal parameters based on the selected virtual path.

18. The system as claimed in claim 12, wherein to estimate the one or more ear canal parameters, at least one processor, individually and/or collectively, is configured to cause the system to:
generate an estimated loudspeaker playback signal based on processing a media playback signal using a loudspeaker model;
generate a compensated feedback audio signal based on de-convolution of the feedback audio signal using the estimated loudspeaker playback signal and the estimated leaked signal;
estimate the one or more ear canal parameters based on the compensated feedback audio signal.

19. The system as claimed in claim 18, wherein to estimate the one or more ear canal parameters, at least one processor, individually and/or collectively, is configured to cause the system to:
transform the compensated feedback audio signal into a sub-band frequency domain compensated feedback audio signal;
determine a dominant frequency band within the sub-band frequency domain compensated feedback audio signal based on performing spectrum whitening on the sub-band frequency domain compensated feedback audio signal; and
estimate the one or more ear canal parameters based on the determined dominant frequency band.

20. The system as claimed in claim 19, wherein to estimate the one or more ear canal parameters, at least one processor, individually and/or collectively, is configured to cause the system to:
select a virtual path, among a plurality of virtual paths stored in a database, based on the determined dominant frequency band, wherein each virtual path indicates one or more acoustic characteristics corresponding to different ear fittings; and
estimate the one or more ear canal parameters based on the selected virtual path.
